(19) United States
(12) Patent Application Publication
(10) Pub. No.: US 2006/0109330 A1
(43) Pub. Date: May 25, 2006

(54) Printer with a reel for supplying an endless web of a recording medium

(75) Inventor: Lodewijk T. Holtman, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/285,075

(22) Filed: Nov. 23, 2005

(30) Foreign Application Priority Data
Nov. 25, 2004 (EP) 04106084.9

(51) Int. Cl. B41J 2/01

(52) U.S. Cl. 347/104; 347/73

(57) ABSTRACT

A printer including a reel for supplying a recording medium in the form of a coil of an endless web wound on the reel, a feed path leading from the reel to a print station, a cutting device disposed at the feed path for cutting the web, and a feed control system, wherein the feed control system is adapted to withdraw a cut end portion of the web onto the peripheral surface of the coil when the printer is in a predetermined operating condition.

### BACKGROUND OF THE INVENTION

The present invention relates to a printer containing a reel for supplying a recording medium in the form of a coil of an endless web wound on the reel, a feed path leading from the reel to a print station, a cutting device disposed at the feed path for cutting the web, and a feed control system. More particularly, the present invention relates to a hot melt ink jet printer.

In printers in which paper sheets or similar image receiving sheets are used as recording media, a tendency of the paper to cockle may sometimes constitute a serious problem. The cockling phenomenon is related to the fact that paper and similar materials tend to absorb humidity from ambient air and to expand and contract in accordance with their humidity content. Typically, the expansion and contraction is unisotropic and is particularly pronounced in a direction in which the fibers of the paper are predominantly oriented. When there exists a gradient in humidity within the paper, then the more humid portion of the paper will expand more than the drier portion, which inevitably leads to the production of cockles or wrinkles.

In a typical set-up of an ink jet printer, especially a large format printer, the paper is intermittently advanced over a flat sheet support plate, while a carriage moves back and forth across the paper, and ink jet printheads mounted on the carriage are energised to eject droplets of ink onto the paper so as to form a printed image. Since the carriage moves with relatively high velocity, the ink droplets ejected onto the paper undergo a certain aberration and are deposited on the paper in a somewhat dislocated position. The amount of dislocation is proportional to the flight distance of the ink droplets. Thus, when cockles are present in the paper, the flight distance is non-uniform and, accordingly, the dislocation of the spots of ink on the paper also becomes non-uniform, so that the quality of the printed image is degraded.

In a hot melt ink jet printer, the ink is solid at room temperature and must be heated above its melting point, typically in the order of magnitude of 100° C., before droplets of liquid ink can be jetted onto the paper. As a result, when the image is being printed, the paper will be heated by the high temperature of the ink, and part of the water that has been absorbed in the paper will evaporate. This creates a humidity gradient in the paper in the area of the print station, and the production of cockles is likely to occur.

### SUMMARY OF THE INVENTION

It is an object of the present invention to provide a printer which is capable of reducing the cockling phenomenon.

According to the present invention, this object is achieved by a printer of the type indicated above, in which the feed control system is adapted to withdraw a cut end portion of the web onto the peripheral surface of the coil, when the printer is in a predetermined operating condition.

The predetermined operating condition may be, for example, a condition in which a print operation is terminated or the printer enters into a standby mode, while a leading edge of the web that has been cut at the cutting device is located in the feed path. Then, an end portion of the web that is present in the feed path will be exposed to ambient air from both sides and can therefore absorb a large amount of moisture, especially when the air humidity is high. If the web would be left in this position for some time and, subsequently, the print operation is continued or restarted, the high humidity content of the leading end portion of the web would give rise to the undesired cockling phenomenon. However, according to the present invention, the end portion of the web is withdrawn onto the coil by rotating the reel in reverse direction. As a result, the entire length of the web is wound on the coil, where it is exposed to ambient air to a significantly smaller degree because, even in the outer layer of the coil, one surface of the web is shielded by the lower layers of the coil, so that the tendency of air to penetrate into the web is greatly reduced. Thus, when the print operation is to be continued and the web is fed again into the feed path, the humidity content of the web will be low and essentially uniform, and, as a result, the cockling tendency is suppressed.

Preferably, a separating mechanism is disposed near the periphery of the coil, so that the leading edge of the web that has been wound onto the coil may reliably be separated from the surface of the coil, e.g., by means or air suction, and may be guided into the feed path. Thus, when the printer is switched on or is switched from the standby mode into the print mode, the web may readily be supplied to the print station without intervention of the user.

Further, the printer may comprise a humidity sensor arranged to detect the degree of humidity of ambient air, and the function of the feed control system may depend upon the detected degree of humidity, so that, when the air is relatively dry and the cockling tendency is low, the leading edge of the web will not be withdrawn but will be left in position at the cutting device, at least during the standby period of the printer. This will speed-up the resumption of the print operation under favourable air humidity conditions.

### BRIEF DESCRIPTION OF THE DRAWINGS

A preferred embodiment of the invention will now be described in conjunction with the drawings, in which:

FIG. 1 shows a schematic vertical cross-section of a paper transport system of a hot melt ink jet printer according to the present invention; and

FIGS. 2 to 4 are enlarged schematic views of a portion of the paper transport system in different states.

### DETAILED DESCRIPTION OF THE INVENTION

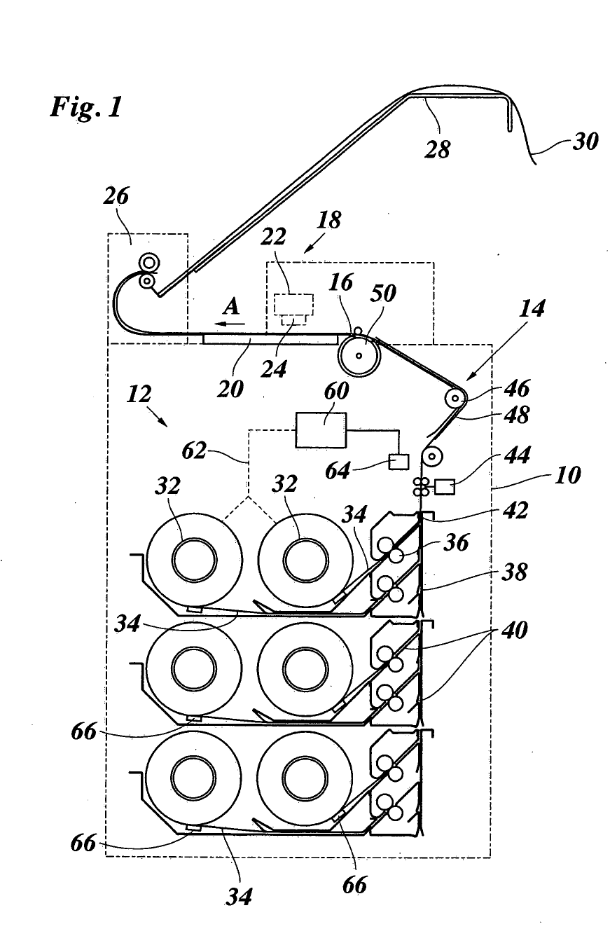

As is shown in FIG. 1, a hot melt ink jet printer includes a frame 10 (which has only been shown in phantom lines) and which accommodates a paper magazine 12 and a paper feed system 14 adapted to feed a sheet 16 of paper to a print station 18 on the top side of the frame 10. In the print station 18, the sheet 16 is drawn against a flat top surface (print surface) of a perforated sheet support plate 20 by means of a vacuum system (not shown). A carriage 22 is arranged to travel back and forth across the sheet 16 in the direction normal to the plane of the drawing in FIG. 1 and carries at its bottom side a number of hot melt ink jet printheads 24 facing the sheet 16. Thus, by energising the printheads 24, a swath of an image is printed in each pass of the carriage 22. Then, the sheet 16 is advanced by a step of appropriate length in a direction indicated by an arrow A, so that the next swath can be printed. A discharge mechanism 26 discharges the sheet onto a tray 28 which, in the example shown, accommodates already a printed sheet 30. The sheet support plate 20 is temperature-controlled in order to control the cooling rate and the solidification of the hot melt ink that has been deposited on the paper. For example, the temperature of the print surface of the sheet support plate 20 is maintained at 32° C.

The paper magazine 12 includes a set of six reels 32 each providing a supply of printing paper in the form of an endless web 34. The reels 32 are arranged in three levels, and the web 34 from each reel is drawn-off by means of a respectively associated pair of transport rollers 36. An arrangement of guide plates 38 defines a branched system of narrow feed paths 40 which merge into a common feed path 42 on the top side of the paper magazine. The pairs of transport rollers 36 are selectively driven to feed the web 34 from a selected one of the reels 32 to the common feed path 42. It will be understood that the reels 32 may contain paper of different qualities and possibly also non-paper recording media such as plastic films or the like. Further, the webs on the reels 32 may differ in width, so that printed sheets may be produced in different formats, ranging for example from A4 portrait to A0 landscape. With the phrase “endless web 34” it is meant that the length of paper on reels 32 is long compared to the cut sizes A4 or A0. Typically the length of such a web is between 20 and 200 meters but can be also longer than that.

From the common feed path 42, the selected web is guided past a cutting mechanism 44 for cutting the web to the desired sheet length, and then the cut sheet 16 is guided over a system of deflection and tensioning rollers 46 and guide plates 48 to a platen 50 from which it is paid out onto the sheet support plate 20.

On its way from the reel 32 to the platen 50, the web 34 and the sheet 16, respectively, will inevitably be exposed to ambient air and, as a result, will absorb humidity, especially when the relative humidity RH of the ambient air is high. In the example shown, the paper is particularly exposed to ambient air in the vicinity of the cutting mechanism 44.

When the humidity content of the paper increases, it tends to expand, in particular in the direction in which the fibers in the paper are predominantly oriented. Typically, this is the direction transverse to the longitudinal direction of the web. When the sheet 16, after having expanded in this way, reaches the sheet support plate 20 and is heated by the hot melt ink deposited thereon, part of the water contained in the paper will be evaporated, and the paper shrinks again in width direction of the sheet. Thus, since a humidity gradient is present in the paper, the accompanying reduction in width of the sheet leads to the production of cockles.

In order to reduce the occurrence of such cockles, it is useful to protect the web 34 as far as possible against contact with humid ambient air. To this end, the paper magazine 12 is capable of withdrawing a web 34, that has been fed into the feed path 42, back onto the coil on the reel 32 from which had been drawn-off. Each of the reels 32 is independently driven by an electric motor, which has not been illustrated, and may rotate in either direction under the control of an electronic feed control system 60, as has been symbolized by dashed lines 62 for the two upper reels 32 in FIG. 1.

The feed control system 60 is also connected to a humidity sensor 64. In the example shown, the sensor 64 is arranged in a position where it can detect the humidity of air near a portion of the paper feed path where the paper is particularly exposed to ambient air. Further, the feed control system 60 is connected to separating mechanisms 66 that are arranged at the periphery of each of the reels 32 at a position where the web 34 is drawn off from the coil.

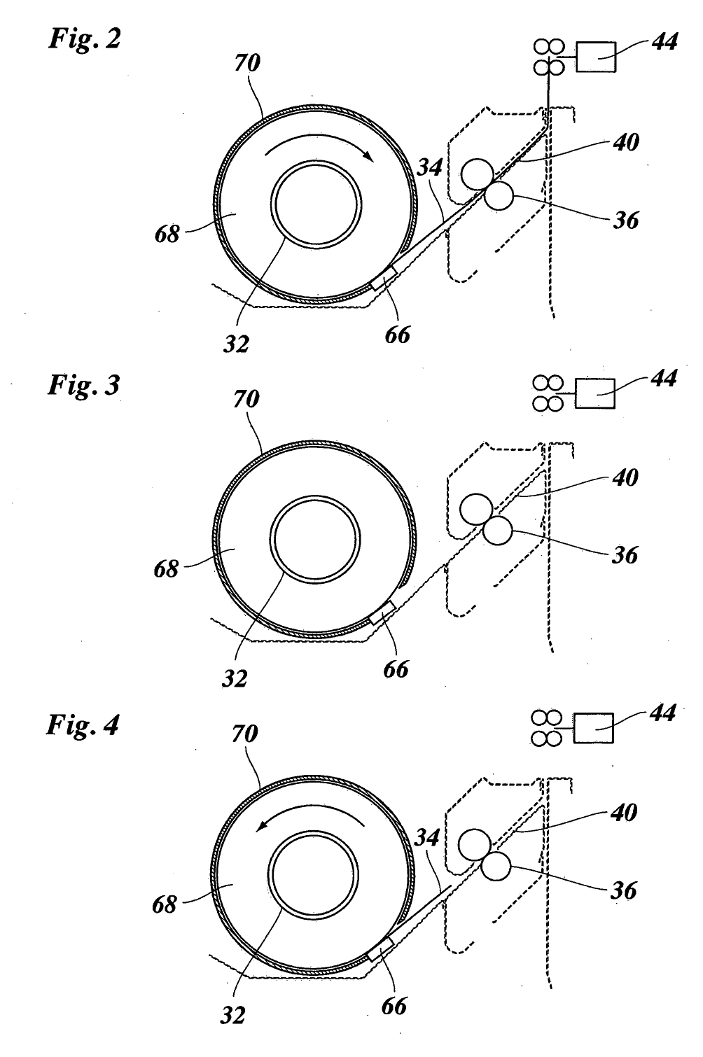

The function of the feed control system 60 will now be explained in detail in conjunction with FIGS. 2 to 4.

FIG. 2 illustrates a condition where a web 34 which has been drawn off from a paper coil 68 on one of the reels 32 has just been cut by means of the cutting device 44, so that the leading edge of the web 34 is located in the paper feed path at the position of the cutting device 44. A cut sheet 16 which has not been shown in FIG. 2, is in the process of being printed. When, at that instant, a new print job has already been programmed, and this print job specifies that the recording medium shall be the same web 34 that is already in the feed path, then the web 34 will be fed further towards the print station 18.

On the other hand, if no new print job is in the print queue, the feed control system 60 reads the air humidity that has been detected by the sensor 64, and if the air humidity is above a certain threshold level of 40% RH, for example, a counter is triggered at the instant at which the cutting device 44 is activated. The counter counts a certain time period the length of which may depend upon the detected amount of air humidity in the sense that the time period is shorter when the air humidity is higher. When the time period lapses without a new print job having been entered, the reel 32 is driven in reverse direction, as is indicated by an arrow in FIG. 2, so as to withdraw the web 34 from the paper feed path and back onto the periphery of the coil 68. The rotation of the reel 32 will be stopped when it is detected that the leading edge of the web 34 has reached the position of the separating device 66. Thus, the entire length of the web 34 is stored in a compacted state in the coil 68, where it is rarely exposed to ambient air. This condition has been illustrated in FIG. 3.

As has been shown in FIGS. 2 to 4, the coil 68 may optionally be surrounded by a shell 70 which is interrupted only at the position of the separating mechanism 66 and assists in protecting the outer layer of the web on the coil 68 against ambient air.

At the time when the web 34 is drawn back onto the coil 68 or at a timing that is determined independently thereof, the printer enters into a standby mode.

When a new print job is entered, the printer is again switched into the operating mode, and the feed control system 60 controls the reel 32 to rotate in forward direction, as has been indicated by an arrow in FIG. 4. Simultaneously, the separating mechanism 66 is activated so as to separate the leading edge of the web from the periphery of the coil 68, e.g., by air suction. It will be understood that the separating mechanism 66 is mounted to be movable in radial direction of the reel 32 so as to adapt to a varying thickness of the coil 68. While the wheel 32 rotates in forward direction, the leading edge of the web 34 is pushed forward until it is captured by the transport rollers 36 and is fed further into the feed path, so that the print operation may be resumed and a new sheet 16 may be cut and printed.

If, in the condition shown in FIG. 2, the detected air humidity is below the threshold level, then the web 34 is left in the paper feed path, so that the print process may be resumed without delay, when a new print job is entered. In this case, the web will only be withdrawn onto the coil 68 when a command is entered for switching off the printer completely.

If, in the condition shown in FIG. 2, a new print job is entered before the counted time period has lapsed or when the air humidity is low, but the new print job specifies that the recording medium shall be taken from another reel, then the web 34 shown in FIG. 2 must be withdrawn to some extent, in order to clear the feed path for the new web. If, at this instant, the air humidity is high, the web 34 will be withdrawn completely, as has been described above. However, if the air humidity is low, the web will only be withdrawn so far that its leading end is still held in the nip between the transport rollers 36, as is conventional in the art, so that this web may readily be supplied into the paper feed path when it is needed again.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A printer comprising at least one reel for supplying a recording medium in the form of a coil of an endless web wound on the reel, a feed path leading from the reel to a print station, a cutting device disposed at the feed path for cutting the web, and a feed control system operatively associated with the reel, wherein the feed control system is adapted to withdraw a cut end portion of the web onto the peripheral surface of the coil, when the printer is in a predetermined operating condition.

2. The printer according to claim 1, wherein said predetermining operating condition is one of:
the condition wherein the printer is being switched off,
the condition wherein the printer is switched to standby,
the condition wherein a predetermined time interval has lapsed after a print job has been completed, without a new print job being entered, and
the condition wherein a recording medium from another reel is selected for printing.

3. The printer according to claim 1, wherein a separating mechanism is disposed at the periphery of the coil for separating the leading edge of the web that has been withdrawn onto the coil, from the coil and feeding it into the feed path.

4. The printer according to claim 1, wherein a humidity sensor is provided for detecting the humidity of ambient air, wherein the feed control system is adapted to withdraw the web only on condition that the detected humidity is above a predetermined threshold level.

5. The printer according to claim 1, wherein the printer is an ink jet printer.

6. The printer according to claim 1, wherein said printer is a hot melt ink jet printer.

7. The printer according to claim 2, wherein a separating mechanism is disposed at the periphery of the coil for separating the leading edge of the web that has been withdrawn onto the coil, from the coil and feeding it into the feed path.
